(19) United States
(12) Patent Application Publication
(10) Pub. No.: US 2020/0397648 A1
(43) Pub. Date: Dec. 24, 2020

(54) Portable tool for sciatic and lower back pain relief with 2 detachable pressure balls for deep tissue massage

(71) Applicant: Amanda Camacho, Orlando, FL (US)

(72) Inventor: Amanda Camacho, Orlando, FL (US)

(21) Appl. No.: 16/444,145

(22) Filed: Jun. 18, 2019

(51) Int. Cl. A61H 15/00

(52) U.S. Cl. CPC A61H 15/00; A61H 2201/0157; A61H 2205/081; A61H 2015/0042

(57) ABSTRACT

A portable apparatus to relief sciatic and lower back pain. The apparatus has an L-shape with an extended curvy corner for more stability. The apparatus includes two pressure balls for different intensity of deep tissue therapy, a metal nut and a metal screw. With the screw hinged into the pressure ball, the screw will go thru a small hole located in the back side of the apparatus and will position firmly the pressure ball. A metal nut will secure the screw in place. The bottom side of the apparatus is slightingly curved, so it can fit comfortably the buttocks natural shape while sitting on it to secure apparatus in place; and the pressure ball will press against the area of pain. The apparatus and the pressure balls are made from recycle plastic material. The apparatus will have two different length sizes options to fit different body types.

This non provisional application claims priority to the provisional application No. 62/920,528 filed on May 6, 2019

This invention will help people that suffers from sciatic pain, piriformis pain, and lower back pain. As a Medical Massage Therapist, the common pain issues are the prior described, and using my expertise, will help people especially if they can't make it to get therapy.

Because is portable, anybody can use it either driving, office, etc. The referred pains can be treated with this tool.

The piriformis is a small muscle located deep in the buttock, behind the gluteus Maximus. It runs diagonally from the lower spine to the upper surface of the femur, with the sciatic nerve running underneath or through the muscle. And with the 2 different detachable balls, will mimic the same treatment from a massage therapist on a sciatic and lower back pain. Each pressure balls have different level of pressure from medium deep tissue to high deep tissue.

The tool can be position in many different ways so you can treat sciatica, lower back pain and piriformis pain. The tool is unique, there is no other similar in the market.

The tool is made from recycle plastic, also the removable pressure balls. The tool has 1 solid piece, the back side is stronger than the lower side, that's why the back side is ⅓-inch-thick, because when using the tool, the back of it needs to hold the pressure from a person leaning against it, in order to feel the pressure ball treating the part affected. The lower side of the tool is slightly curve, to fit the natural curve of the buttocks of whoever is using the tool. The whole piece has a 9.5 inches in length, the bottom side is 4.5 inches' length, back side is 5 inches' length, the tool is 4 inches' width, and ⅓ inch thick. Pressure ball is located 1½ inches from the top of the back side of the tool.

The pressure balls have attach a metal screw which is 10×32-1¼-inch length to secure them to the back of the sciatic tool.

### DESCRIPTION OF DRAWINGS AND ITS FUNCTIONS

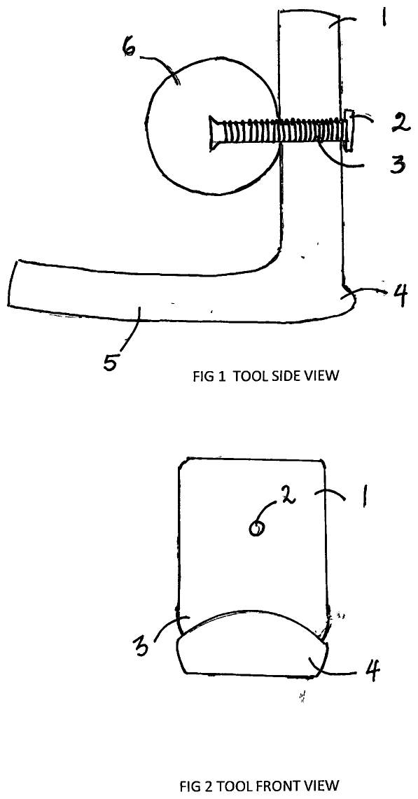

FIG. 1 Tool Side View
1) Back side of the sciatic tool.
2) 10×32 screw nut to secure the pressure ball.
3) 10×32-1¼-inch-long screw attach to the pressure ball.
4) Bottom back side of the tool, the pointy form is to have more leverage on pressure towards the points of pain.
5) Bottom part of the tool, its slightly curvy form is to fit comfortably the gluteus muscle and help level that part of the body to get the pressure relief.
6) Plastic pressure ball, are removable, a total of 2. The difference is for deeper pressure. Diameter of 2.5 Centimeters for the circular one and 3 cm for the oval one. The pressure balls have a screw attachment, to keep it secure to the sciatic tool.

FIG. 2 Tool Front View
1) Top of the tool, ⅓-inch-thick and 4 inches' width
2) ¼ cm hole to insert the screw that is attach to the pressure ball.
3) Bottom back curve part, partially side view.
4) Bottom side of the tool, this will be placed on the buttocks, and securely will stay in place for the treatment.

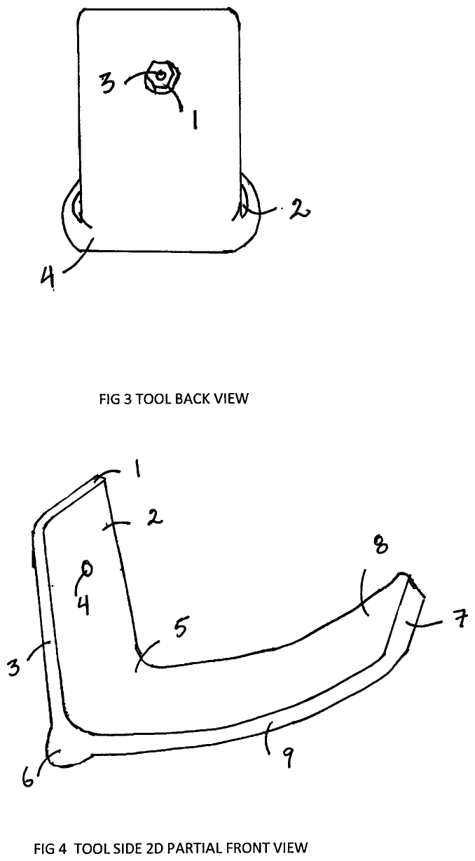

FIG. 3 Tool Back View
1) View of the screw nut that will help secure in place the pressure ball.
2) Bottom back side of the tool, the pointy form is to have more leverage on pressure towards the points of pain.
3) Bottom side of the screw that is attached to the pressure ball
4) Bottom pointy part of the sciatic tool.

FIG. 4 Side 2D Partially front View
1) Top border side of the tool. ⅓-inch thickness, and 4 Inches width
2) Top part of the back side of the tool
3) Side border of the tool.
4) A ¼ cm hole to insert the pressure ball.
5) Lower curvy part of the tool
6) Bottom back side of the tool, the pointy form is to have more leverage on pressure towards the points of pain.
7) Front border side of the tool.
8) Bottom part of the tool
9) Side border of the bottom part of the tool.

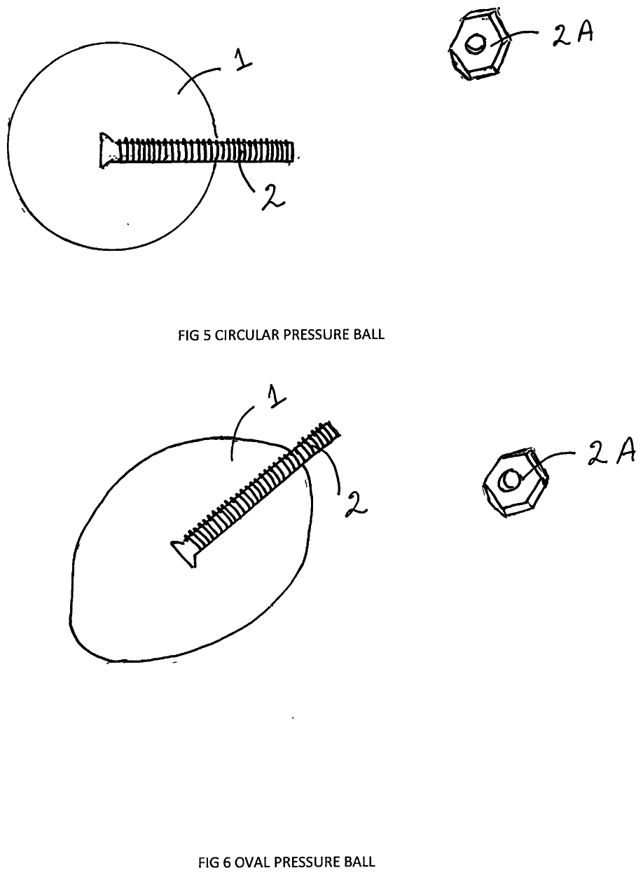

FIG. 5 Pressure Ball attachments
1) Body of pressure ball 2.5 cm diameter
2) Metal screw inserted thru the plastic pressure ball, measurements 10×32-1¼ length, this will help keep the pressure ball in place attach to the back side of the sciatic tool
2A) Screw nut that will be attached to the other side of the back side of the sciatic tool to secure the metal screw

FIG. 6 Pressure Deep Oval attachment
1) Body of deeper pressure Oval. 3 cm diameter
2) Metal screw inserted thru the plastic pressure ball, measurements 10×32-1¼ length, this will help keep the pressure ball in place attach to the back side of the sciatic tool.
2A) Screw nut that will be attached to the other side of the back side of the sciatic tool to secure the metal screw.

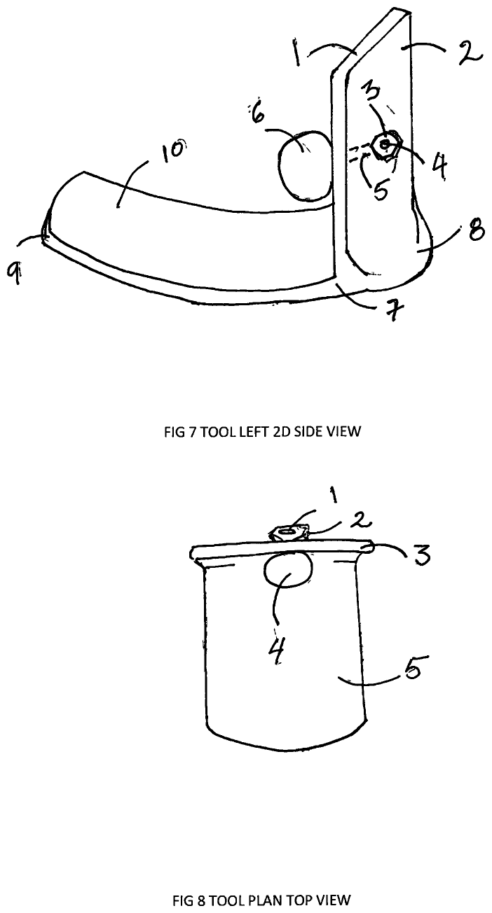

FIG. 7 Sciatic tool left 2D side View.
1) Top border tool view
2) Back side of the tool view
3) Screw nut that will secure the pressure ball
4) Bottom part view of the screw that is attach to the pressure ball
5) Plastic circular pressure ball screw attachment location
6) Plastic pressure ball
7) Side border view of the back of sciatic tool
8) Bottom back side of the tool, the pointy form is to have more leverage on pressure towards the points of pain.
9) Side border view of the bottom side of the tools.
10) Bottom side of the tool, to be placed under Buttocks when getting therapy with the tool.

FIG. 8 Plan Top View
1) View of the bottom part of the screw that is attach to the pressure ball
2) Side view of the screw nut that helps hold the screw and the pressure ball secures to the sciatic tool
3) Border top view of the back side of the tool
4) Top view of the pressure ball attach to the back side of the tool
5) Top view of the Bottom part of the tool

1. An apparatus for sciatic and lower back pain relief comprising:
a body defining an L shape with round corner; said body having a back side and a bottom side, said bottom side is positioned horizontally, and at the bottom end of said bottom side of said body is a flat curvy end to give more balance and stability to the said body; use drawings as reference.
a hole situated in the back side of said body, said hole allow insertion through;
a pressure ball position on back side of said body and attached to a metal screw, allowing insertion of said pressure ball and said metal screw through said hole;
a nut attaching said metal screw to the said back side of said body;
an imbedded horizontally metal screw in said pressure ball, allowing insertion through said hole.

2. The apparatus as in claim 1 wherein said body have and L shape with a round corner.

3. The apparatus as in claim 1 wherein said body having a back side with a length of 5 inches and a Width of approximately 4 inches and a bottom side with a length of 4.5 inches and a width of Approximately 4 inches of said bottom side.

4. The apparatus as in claim 1 wherein said body having a bottom side positioned horizontally, and at the bottom end of said bottom side of said body is a flat curvy end to give more balance and stability to the said body. Use drawings as reference.

5. The apparatus as in claim 1 wherein said hole is located in the said back side of said body. Said hole's position is 1.5 inches down from the top of said back side of said body; said hole has a diameter of ¼ cm. Said hole will allow insertion through said imbedded horizontally metal screw, and retain in place the said pressure ball.

6. The apparatus as in claim 5 wherein said pressure ball had said imbedded horizontally metal screw; and said pressure ball is secure in place by the said imbedded metal screw and said nut. Said pressure ball and said nut are spaced apart by the said back side of said body.
Said pressure ball function is to provide deep pressure for sciatic and low back pain.
